(19) United States
(12) Patent Application Publication
(10) Pub. No.: US 2018/0361489 A1
(43) Pub. Date: Dec. 20, 2018

(54) Laterally Stiffened Circular Saw Blade

(71) Applicant: Warren M Bird, San Francisco, CA (US)

(72) Inventor: Warren M Bird, San Francisco, CA (US)

(73) Assignee: Katrina Lines-Richwine, San Francisco, CA (US)

(21) Appl. No.: 16/114,186

(22) Filed: Aug. 27, 2018

Related U.S. Application Data
(63) Continuation-in-part of application No. 15/421,079, filed on Jan. 31, 2017, now abandoned.

(51) Int. Cl. B23D 61/02

(52) U.S. Cl. CPC B23D 61/025; B23D 61/021

(57) ABSTRACT

A thin kerf commercial circular saw blade designed for accurate commercial lumber sawmill cutting of green wood, having a saw plate with three concentric regions of differing thicknesses and widths. This design goes against traditional thinking of lateral blade stiffening in that no part of the blade has a width exceeding the width of the kerf and the stiffened region exceeds to within ⅛ of an inch of the saw tooth tip.

### PRIORITY

This continuation-in-part utility patent application claims domestic priority from utility application Ser. No. 15/421,079 filed Jan. 31, 2017 and entitled “CIRCULAR SAW PLATE WITH THICKNESS DISCONTINUITY” which claims domestic priority from utility application Ser. No. 13/907,662 filed May 31, 2013 and entitled “CIRCULAR SAW PLATE WITH THICKNESS DISCONTINUITY”, which claims priority to provisional patent application Ser. No. 61/784869 filed Mar. 14, 2013 entitled “CIRCULAR SAW PLATE WITH THICKNESS DISCONTINUITY.” All applications incorporate by reference those applications from which they claim priority.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to commercial circular saw blades with an optimized design for increased cutting accuracy, and performance, and more particularly to increased saw blade lateral stability design for commercial lumber mill thin kerf cutting in green or wet wood.

### BACKGROUND

When commercially cutting trees and dimensional lumber at a lumber mill there are the following four major considerations: the amount of wood lost to the cutting process; the amount of sawdust waste generated; the accuracy of the cuts made; and the longevity and downtime of the saw blade. The prior art and conventional wisdom has led to the development of thin kerf circular saw blades having narrower hardened tips rigidly brazed to the outer periphery of the saw blade body. While reducing waste and requiring less power to operate, these thin kerf blades are not without their own problems. The most critical downfall is that the cutting accuracy with thin kerf blades is inferior to that attained with standard wide kerf saw blades.

A thin kerf blade with enhanced lateral stability to increase cutting accuracy would fulfill a long felt need in the lumber mill industry. This new invention utilizes and combines known and new technologies in a unique and novel configuration to overcome the aforementioned problem and accomplish this.

### BRIEF SUMMARY

In accordance with various embodiments, an improved design for a thin kerf circular saw blade for accurate commercial lumber sawmill cutting is provided.

In one aspect, a commercial circular saw blade having increased lateral stability over the prior art is provided.

In another aspect, a commercial circular saw blade is provided, capable of several sharpenings of its hardened tips.

In yet another aspect, a commercial circular saw blade capable of dissipating any frictional heat building into the blade without reducing the stiffness of the saw blade is provided.

In yet another aspect, a commercial saw blade is provided that can minimize any stress cracking at thickness transition regions of the blade body.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is a side view of a conventional circular saw blade blank for lumber mill cutting operations with green wood prior to the gullet formation and tip brazing,

FIG. 2 is an enlarged view of region Z of FIG. 1 after gullet formation and tip brazing;

FIG. 3 is side view of a tooth;

FIG. 4 is a front view of a tooth in the region A-A of FIG. 3;

FIG. 5 is a side view of a tooth in the region A-A of FIG. 3;

FIG. 6 is a top view of a tooth in the region B-B of FIG. 3;

FIG. 7 is a top view of a tooth in the region B-B of FIG. 3;

FIG. 8 is a front partial view of the laterally stiffened circular saw blade blank prior to the gullet formation and tip brazing;

FIG. 9 is a side view of the region Y of FIG. 8 after gullet formation and tip brazing; and

FIG. 10 is a front, cross sectional, partial view of the laterally stiffened circular saw blade.

### DETAILED DESCRIPTION

While various aspects and features of certain embodiments have been summarized above, the following detailed description illustrates at least on exemplary embodiment in further detail to enable one skilled in the art to practice such an embodiment. The described example is provided for illustrative purposes and is not intended to limit the scope of the invention.

In the following description, for the purposes of explanation, numerous specific details are set forth in order to provide a thorough understanding of the described embodiment. It will be apparent to one skilled in the art, however, that other embodiments of the present invention may be practiced without some of these specific details.

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

Unless otherwise indicated, all numbers herein used to express quantities, dimensions, and so forth, should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

The present invention relates to a novel design for a circular saw blade for use in sawmills sawing logs and log segments into dimensional lumber. Here, the wood is green and generally sawed wet, utilizing hydrodynamic saw guides with the cutting process incorporating water spray. Heat buildup in the saw blade is a consideration but not to the degree it is when cutting dry wood. However, in this type of cutting, the dimensional tolerances needed are quite exacting. Additionally, there is a huge throughput of lumber giving rise to two problems, massive amounts of sawdust and lost material in kerf width. Lateral defection of the saw blade under load is critical and must be held as small as possible. Saw blades for this type of cutting generally are in the 22 to 27 inch diameter range and are used with a spline arbor saw which allows for smaller diameter, thin kerf saw blades.

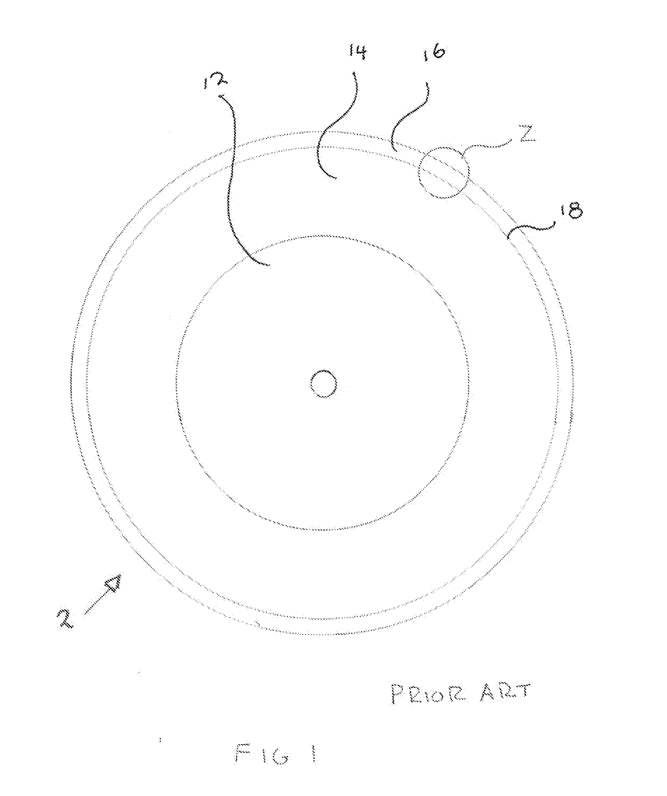

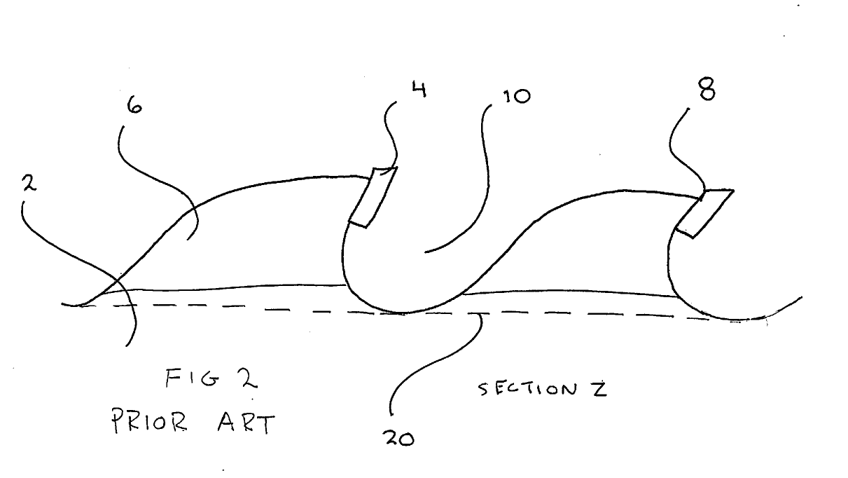

The description of a circular saw blade generally, will be discussed with respect to the prior art. A circular saw blade is comprised of a saw plate 2 (FIG. 1) to which is affixed a series of saw tooth tips 4 (FIG. 2). The saw plate (or blank) 2 is a circular disk with equally radially spaced teeth 6, arrayed about its periphery. Brazed at the end of each of the teeth 6 and extending beyond the tooth's outermost point 8 is a saw tooth tip 4 which cuts the wood. (FIG. 2) Generally, these saw tooth tips 4 are sharpened blocks of a stellite steel alloy or of sintered tungsten carbide. Adjacent teeth are separated by spaces known as “gullets” 10 which serve to capture chips or sawdust generated by the cutting process. The saw tooth tips 4 come in a plethora of different geometric configurations and any single saw blade may have all identical saw tooth tips 4 affixed thereon or may have an alternating array of different shaped saw tooth tips 4, depending on the specific intended purpose of the saw blade.

The saw plate 2 is made of an alloyed steel that has a hardness as measured on the Rockwell C scale of 44-45 for a saw blade having a kerf in the 0.120 inch width. The saw blade stiffness is increased for wider kerfs into the Rockwell C range of 45-48, and reduced for narrower kerfs into the 42-44 Rockwell C range.

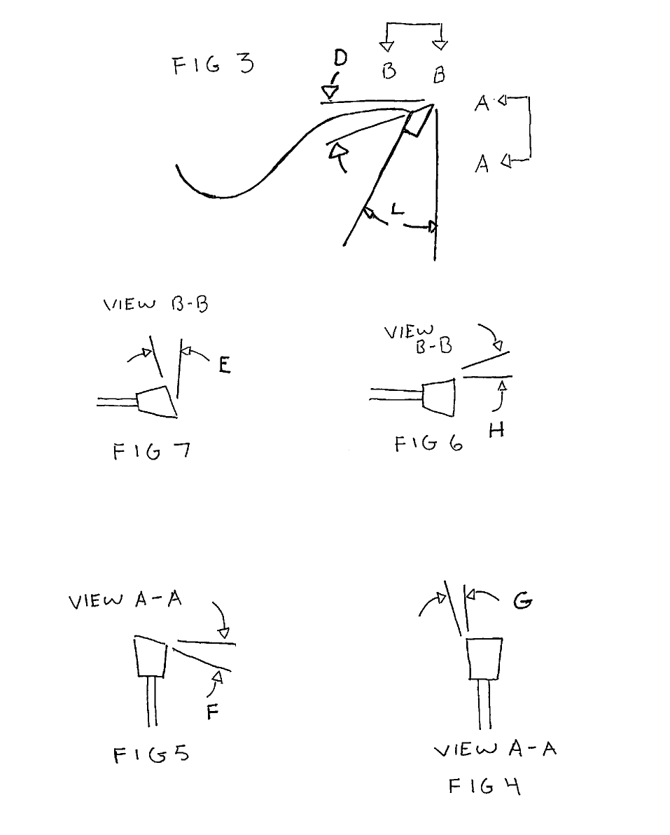

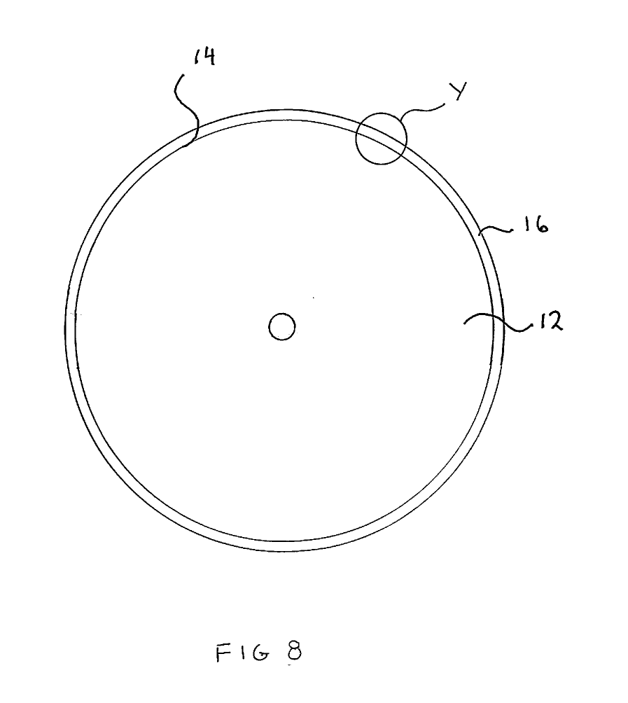

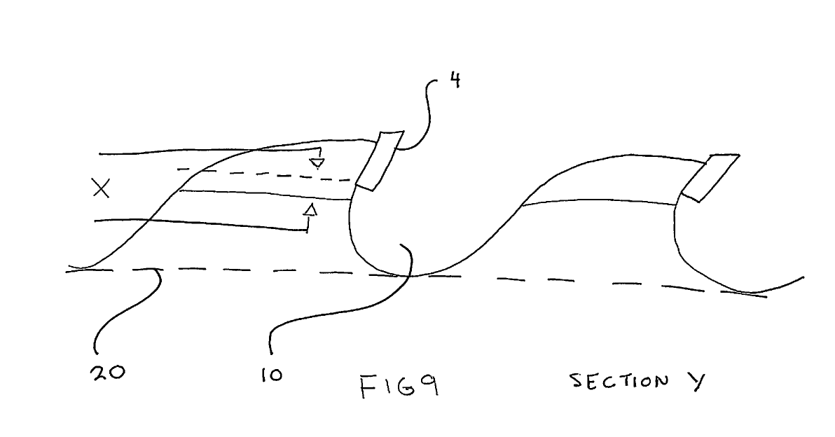

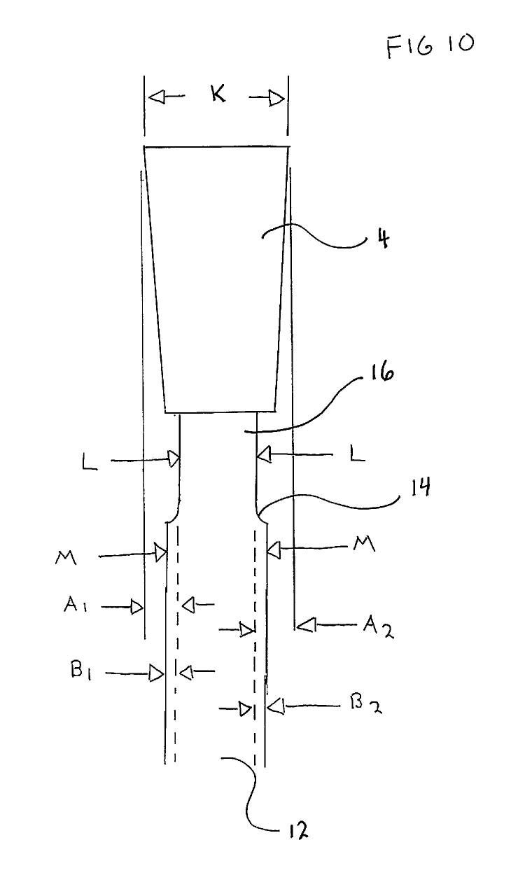

The saw tooth tips are characterized by their size and bevel geometry of their various faces. This is seen as: their width known as the “saw kerf' (designated as dimension K of FIG. 10); their length; their thickness; their rake (or hook) angle (designated as dimension L of FIG. 3); their top clearance angle (designated as dimension D of FIG. 3); their face bevel angle (designated as dimension E of FIG. 7); their top bevel angle (designated as dimension F of FIG. 5); their radial clearance angle (designated as dimension G of FIG. 4); and their tangential clearance angle (designated as dimension H of FIG. 6). There is a decreasing thickness of the saw tooth tip from the top to bottom and from the front to the back of the tip to reduce the drag of the saw blade on the work piece.

In order to avoid friction between the wood work piece and the saw plate, the saw kerf must be greater than the saw plate thickness. The leading contact edges of the saw tooth tips 4 do the only cutting of the wood and the gullets 10 do the only collection and ejection of the sawdust created in the cutting process. As can be envisioned looking at FIGS. 4 and 3 the radial and tangential clearance angles G and D reduce friction between the work piece and the sides of the tooth tip.

The remaining parts of the circular saw blade must not touch the wood as any contact would result in friction which would increase the work load on the saw, would cause binding, cause friction heat buildup in the blade, and cause deviation from the saw blade's intended cutting line of the wood.

While the solution to minimizing the saw load and reducing the material waste is clearly to use thin kerf saw blades, these thin kerf blades create the problem of reduced saw accuracy. With the reduced width of the saw tooth tips (the kerf), the beveled faces of the saw toot tips, and the need to ensure no contact between the saw plate and the work piece material, the thickness of the saw plate approaches the point where its does not offer enough lateral support (stiffness) to prevent the deflection of the saw blade. This is the most critical feature of a commercial saw blade—to be able to cut accurately and straight. Although the deflection of the saw blade may be caused by various different mechanisms, the solution to inaccurate cutting (kerf wander) is the same. The saw plate must be made stiffer which in turn can only be accomplished with stiffer steels and thicker saw plates. Since the steel selection has long been optimized for this scenario, this leaves only maximizing the saw plate thickness within operable parameters for that width of saw kerf.

To complicate matters, these commercial blades are expensive and need to be re-sharpened to make them cost effective. Because of the presence of the radial and tangential clearance angles, re-sharpening the saw tooth tips (by grinding the face and/or top surfaces) results in reduction of the saw kerf, and, hence, of the amount of clearance between the saw kerf and the saw plate. Thus, the initial difference between the saw plate tooth thickness and the magnitude of the saw kerf must be great enough to accommodate several cycles of operation after re-sharpening before the saw tooth tip must be removed and replaced by a tip of the original dimensions. The operation of these re-sharpened saws although with a slightly diminished kerf, must also avoid any contact between the saw plate and the work piece material.

As a final consideration, frictional heat buildup in a saw blade starts at the saw tooth tips and teeth at the outer periphery and spreads inward toward the center of the blade. The smaller the width is of the blade ring, the less heat it can absorb before it expands and distorts with respect to the other thicker blade rings which can absorb more heat before expanding.

The best practices for sawing with blades that were loosing accuracy for a given wood and cut depth was to add blade stabilizers to the sides of the saw plate. These were either tapered or flat steel discs that were mounted on both sides of the saw plate and extended outward to a point less than the depth of the cut. This outward limitation (the diameter of the blade stabilizers) was because the thickness of these plates exceeded the side clearance dimensions of that saw tooth tip and saw plate and would physically abut the cut edge of the work piece and thus limit the depth of cut. In order to add the maximum stiffness to thin kerf blades and prevent flexion along the saw blade's diameter, it was thought that making the inner ring of the saw blade much thicker than the kerf width would drastically increase the stiffness of the saw blade and would solve the problem. This first generation thin kerf blade would eliminate the need for blade stabilizers as the blade itself would just be stiffer. This met with limited success and accuracy was increased, however the depth of cut was limited by the diameter of the inner ring of the saw blade.

The second generation thin kerf saw blades incorporated a broad width transitional region 14 between the inner stiffening ring 12 and the tooth ring 16 and decreased the diameter of the inner ring of the saw blade. FIG. 1 illustrates such a prior art thin kerf circular saw plate 2 prior to the formation of the gullets 10 and the brazing of the saw tooth tips 4. While the tooth region 16 and the inner stiffening region 12 had parallel sides and thicknesses less than and greater than the kerf width respectively, the transitional ring 14 tapered in width from the thickness of the tooth ring 16 to the thickness of the inner stiffening ring 12. This allowed for increased stiffness as well as increasing the depth of cut. In these designs the transitional ring 14 may approach 13 the diameter of the saw blade and the leading edge 18 of the transition ring 14 approached and even exceeded slightly the bottom of the gullets 20.

Recognizing that in a static situation, the lateral deflection of the plate is function of the cube of the thickness of the saw plate, the current saw plate design goes against the prevailing, prior art methodology and does not utilize a saw plate having any thickness greater than the kerf width. While the prior art circular saw blades solved the problem of blade stiffening thin kerf saw blades with saw plate rings thicker than the kerf width, the present saw plate uses a three ring design with the thickness of these three rings lying in ranges determined by a set of formulas, and extending the inner ring deep into the gullets. Since the first and second rings have very small widths, the majority of the saw blade has a uniform thickness and distortion and stress cracking is minimized.

In the way of an example, looking at FIGS. 8, 9 and 10, a typical laterally stiffened circular saw blade will have a kerf width (or saw tooth tip width K) of 0.120 inches, a total side clearance dimension in the tooth ring 16 of the kerf width K minus the thickness L of the tooth ring 16 (K−L) of 0.040 inches (rule of thumb is 0.020 inches of side clearance per saw side, + or −0.005 inches) giving a tooth ring thickness of 0.080 inches. The distance from the bottom of the saw tooth tip to the beginning of the tooth ring X is approximately ⅛ inch (+ or − 1/16 inch) to allow for re-sharpening grinder wheel access. The thickness M of the inner stiffening ring 12, is approximately the thickness of L the tooth ring (0.080) plus ⅓ of the total side clearance between the kerf thickness and the tooth ring thickness (L+(K−L)/3=0.093 inches). The transitional ring 14 is very narrow and comprises a width on either side of the saw blade that is no less than the ½ of the difference in the thickness between the inner stiffening ring M and the thickness of the tooth ring L (B1+B2). The transition ring 14 in the preferred embodiment has a ¼ circular arc with a radius equal to ½ of ⅓ of the amount of side clearance between the kerf K and the width L of the tooth ring 16. ((K−L)/6=−0.0065 inches) This circular arc will never be less than this amount and never exceed twice this amount. (0.0013 inches) The goal is to minimize the width of the transition ring 14 to get the maximum width of stiffened inner ring onto the saw plate without incorporating too sharp an interface edge that results in points for the propagation of stress cracks. The sharper the interface edge is between the transition ring 14 and the inner ring 12 the less material there is behind this interface edge and the easier it is to develop a crack.

It is to noted that the saw blade of FIG. 10 is a symmetrical blade wherein the amount of side clearance between the kerf and each side of the inner ring are identical (A1=A2), and wherein the difference between the thickness of the inner stiffening ring and the tooth ring on either face of the saw plate is also identical (B1=B2). This may not always be the case. For this reason the formulas incorporate the summation of dimensions from each side of the saw plate. Rather than calculating the thickness M of the inner stiffening ring 12 as the thickness L of the tooth ring plus ⅓ of the difference in thickness between the kerf width K and the total side clearance L, it is more properly expressed as the thickness of the tooth ring L plus ⅓ the combined difference of the amount of side clearance between each of the faces of the tooth ring and the sides of the kert (the outermost edges of the saw tooth tip on each side of the saw plate) shown as A1 and A2. The transitional ring 14 has a conventional quarter circular profile that may differ between the two faces of the saw blade if the saw blade is not a symmetrical blade. Thus, the width of the transition ring 14 on either side of the saw may vary and will be no less than ½ of ⅓ of the difference in thickness between the kerf width K and the tooth ring width on either side of the blade (seen as dimensions B1 and B2).

Gullets generally are about 1-0.75 inch deep, being sized for the collection of sawdust considering the depth of the cut, the number of teeth and the thickness of the kerf.

Experimentation with this saw plate dimensioning has led to the following critical equations defining dimensional parameters that must be adhered to where the saw blade is symmetrical about its linear axis.

The transition ring begins at ⅛ inch from the bottom of the saw tooth tips plus or minus 1/16 of an inch. (It must occur well up in the gullet not at the bottom.)

The transition ring must have a radius no smaller than ½ of ⅓ of the difference of the side clearance of that face of the saw plate. The radius must not exceed ⅓ of the difference of the side clearance of that face of the saw plate.

The width of the transition ring must be no less than ⅓ of the difference of the side clearance of that face of the saw plate. (⅙ of the difference of the total side clearance between the kerf and the inner stiffening ring for symmetrical saw blades) The width must not exceed ⅔ of the difference of the side clearance of that face of the saw plate. (⅓ of the difference of the total side clearance for symmetrical saw blades.)

The ratio of the difference between the thickness of the inner ring and the tooth ring is equal or greater than 1.10. (M/L is = or >1.10)

The ratio of the combined thickness of the difference between the inner ring and the tooth ring to the combined side clearance between the kerf and the tooth ring to is equal to or greater than 0.20. (B1+B2/A1+A2 is = or >0.20)

Experimentation on thin kerf circular saw blades built within the above tolerances as compared to prior art blades with wide transition rings and thicker inner rings for the same cut depth, exhibit an increased lateral stiffness. Overall, there is up to a 1/3 increase in the measured accuracy of the cuts. Much of this accuracy comes as an unexpected result of the stiffening of the saw blade. Since the saw blade is clamped in the region of the bottom of the gullets when the saw tooth tips are to be re-sharpened, any additional thickness in the tooth ring region prevents deflection of the saw teeth when they are under side load as the grinding occurs. This allows for a better angular symmetry of the teeth when they are sharpened, wherein the radial and tangential side clearance angles are much more uniform.

Prior art patents such as U.S. Pat. No. 4,979,417 to the present inventor reflect the state of the art thinking and design in thin kerf circular saw blades at the time. These recognized the need to increase saw blade lateral stability through a saw plate having a thickness in excess of the thickness of the saw blade at the saw teeth. However, here they taught against the design of the present invention where they reasoned that an excessively thick inner ring was best to increase the lateral stiffness of the blade. Between the saw blade's tooth ring, which maintained a side clearance thickness dimension comparable to what is still currently used (in the 0.010 to 0.103 inches range) and the excessively thick inner ring, they were forced to use a long transition region of gradual increasing tapered thickness. This was to ensure that there was no transition interface with sharp edges that would be prone to stress cracking. Because there was such a dramatic difference between the thickness dimensions between the innermost and outermost sections of the blade plate, this second tapered transition region extended quite far into the body of the saw plate. Additionally, the leading, front edge of this transition region was barely into the bottom of the gullet. It is now known from experimental results, that they overcompensated with the thickness of inner region and undercompensated with the distance the transitional region extended into the gullet. The resultant blade did not dramatically offer good operational stiffness and did not offer the stiffness at the teeth to enable highly accurate tooth tip grinding. Consequently, the cutting accuracy was not dramatically improved.

The present design offers a dramatic increase in cutting accuracy while still allowing multiple re-sharpening through the use of a blade designed to reside within specific ranges.

While certain features and aspects have been described with respect to exemplary embodiments, one skilled in the art will recognize that numerous modifications are possible.

1. A circular saw blade comprising:
a first tooth ring having a first outer edge, a first inner edge, a first thickness, and a first width;
a second transitional ring having a second outer edge, a second inner edge, a second thickness, and a second width, a third inner stiffening ring having a third outer edge, a third inner edge, a third thickness and a third width;
said rings formed concentrically on a planar, circular steel disc with said second transitional ring lying between said first tooth ring and said third inner stiffening ring, said disc having a midpoint, an outer periphery edge, a first side face, and a second side face,
a series of equally radially spaced teeth formed on said outer periphery edge;
a series of gullets formed on said outer periphery edge between said teeth;
a series of saw tooth tips affixed to each of said teeth at the top of said gullet, said saw tooth tips having a top, a bottom, and a kerf width;
wherein said first thickness is less than said second thickness which is less than said third thickness.

2. The circular saw blade of claim 1 wherein said first tooth ring extends from said outer periphery to ⅛ of an inch, plus or minus 1/16 of an inch, from said bottom of said saw tooth tips.

3. The circular saw blade of claim 2 wherein said third thickness is the sum of the first thickness plus ⅓ of a difference between said kerf width and said first thickness plus or minus 0.005 inches.

4. The circular saw blade of claim 2 wherein said second transitional ring has a width between one half and one times of a difference between said first thickness and said third thickness.

5. The circular saw blade of claim 3 wherein said second transitional ring has a width between one half and one times of a difference between said first thickness and said third thickness.

6. The circular saw blade of claim 2 wherein a difference between said kerf width and said first width is 0.020 plus or minus 0.005 inches.

7. The circular saw blade of claim 3 wherein a difference between said kerf width and said first width is 0.020 plus or minus 0.005 inches.

8. The circular saw blade of claim 4 wherein a difference between said kerf width and said first width is 0.020 plus or minus 0.005 inches.

9. The circular saw blade of claim 4 wherein a ratio of the difference between said third thickness and said first thickness is equal or greater than 1.10.

10. The circular saw blade of claim 8 wherein a ratio of the difference between said third thickness and said first thickness is equal or greater than 1.10.

11. The circular saw blade of claim 4 wherein a ratio of the difference between said third thickness and said first thickness to a difference between said kerf width and said first thickness is equal to or greater than 0.20.

12. The circular saw blade of claim 8 wherein a ratio of the difference between said third thickness and said first thickness to a difference between said kerf width and said first thickness is equal to or greater than 0.20.
